(19) United States
(12) Patent Application Publication
(10) Pub. No.: US 2004/0180751 A1
(43) Pub. Date: Sep. 16, 2004

(54) Automatic transmission for motor vehicles

(76) Inventors: Axel Heitmann, Friedrichshafen (DE); Ralf Dreibholz, Friedrichshafen (DE); Gerhard Gumpoltsberger, Friedrichshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/485,873

(22) PCT Filed: Aug. 14, 2002
(86) PCT No.: PCT/EP02/09088

(30) Foreign Application Priority Data
Aug. 17, 2001 (DE) 101404239

(51) Int. Cl. F16H 3/44

(52) U.S. Cl. 475/284

(57) ABSTRACT

An automatic, shiftable vehicle transmission (1) with an input drive shaft (2), which can be connected to an internal combustion engine, and an output drive shaft (3) which is connectable to at least one vehicle axle, a mechanical shifting gear train (4) with a first and a second planetary gear set (5, 6), as well as a plurality of shifting elements (7, 8, 9, 10, 11, 12). The first planetary gear set (5) is a simple planetary gear set and the second planetary gear set (6) is a double, in particular, a Ravigneaux gear set (6). The second planetary gear set (6) is located after the first planetary gear set (5). A first shaft (14) is connectable via an additional shifting element (13) with a second shaft (16) of the first planetary gear set (5) and thereby, two further forward gear stages and an additional reverse gear stage can be realized.

The invention concerns an automatically shiftable vehicle transmission, having an input drive shaft which is to be connected to an internal combustion motor, and possessing an output drive shaft connectable with at least one vehicle axle, as well as being equipped with one mechanical shifting transmission with a first and a second planetary gear set, wherein the first planetary gear set is designed as a simple planetary gear set and the second planetary gear set is constructed as a doubled planetary gear set, that is to say, especially made as a Ravigneaux set. The doubled planetary gear set is located remote from the input end, i.e., located after the first planetary gear set. Further, the shifting element for the said shifting is provided with a plurality of forward stages and at least one reverse stage.

An automatic multistage transmission with a mechanically shiftable transmission of prior art is taught by EP 434 525 B1. With that transmission it is possible for one to shift into, for example, six forward gear stages and one reverse gear stage.

As an extension to the above automatic transmission, is also described a transmission with an electromagnetic machine designed as a starter/generator. The description of this said transmission is to be found in VDI-Reports, Nr. 1610, 2001, pages 455 to 479, entitled “E Automat, Automatikgetriebe mit Esprit” by Professor Dr. P. Tenberge of Chemnitz, Germany. The said transmission so described, is provided, for the purpose of shifting, with seven forward stages and one reverse stage, as well as with stepless changing of the ratio in five forward gear changes. In this case, because of a designed exclusion of a hydrodynamic converter, space has been acquired for the said electromagnetic machine.

The procedure for start-up driving can be carried out, due to the above design, in three different ways, which are, namely, a) a purely electric motor system, b) utilizing the internal combustion motor with an additional brake as a start-up element, or c) utilizing the internal combustion motor together with an electric motor, which, in this case fulfills the function of the brake.

By the adding of a control unit as well as a storage battery, an advantageous, supplementary driving advantage is achieved, which incorporates, along with a comfortable start-stop operation, a stepless drive in part of the gear range, and an electrical booster of energy recovery possible upon braking. Another advantage is a purely electrical, emission-free operation. In the case of the previously mentioned “E-Automat” the internal combustion engine and the electrical machine are coupled together by means of a planetary gear set, so that the planetary gear set can determine the torque ratio of the two driving aggregates.

The purpose of the invention is to make an additional shifting possibility for transmissions with mechanical shifting availableand thereby, to enable a transmission with more shift-stages and which has a minimalized construction.

This purpose is achieved by an automatically shiftable vehicle transmission of the prior art with the features of claim 1.

In accordance with the invention, an additional shifting element for the connection of a gear of the first planetary gear set is proposed to be connected to a second gear of the first planetary gear set. By the closing of this additional shifting element, that being a clutch, the achievement gained is that the first planetary gear set is blocked, so that, advantageously, two additional forward gears as well as one additional reverse gear become available. Thereby the realization of the purpose of the invention enables nine forward gear stages and two reverse gear stages.

By means of the additional shifting elements, the sun gear of the first planetary gear set is made connectable with the internal gear of the first planetary gear set. Thereby, in an advantageous manner, the first planetary gear set is blocked so that the output drive shaft speed of rotation of the first planetary gear set now matches the speed of rotation of the first planetary gear set of the input drive shaft and the first planetary gear set exhibits the ratio of i=1.

In an advantageous development of the invention, the proposal is to bind the sun gear with a sun gear shaft and the internal gear with an internal gear shaft, that by means of the additional shifting element, the sun gear shaft can be connected to the internal gear shaft of the first planetary gear set.

Advantageously, the internal gear shaft of the first planetary gear set is bound to the input drive shaft of the vehicle transmission, thus allowing a direct input drive of the internal gear shaft, and therewith enabling a simpler method of construction of the first planetary gear set.

The additional shifting element, advantageously, can be made as a lamella clutch as well as a shape-fitting clutch, or yet be designed as an over-running clutch.

A space saving and economical combination of the shifting elements is proposed by the placement of the additional shifting elements as being coaxially arranged in regard to the internal gear shaft and/or to be coaxial to the sun gear shaft. Further, the axial arrangement of the shifting elements between the input shaft and the first planetary gear set also contributes to space saving and economy.

Additional goals, advantages and formulations of the invention arise from the following description of embodiments thereof. In this way all features, described and/or depicted, of themselves or in optional logical combination, form the object of the invention, independent of their summary in the claims and the retro indications thereof.

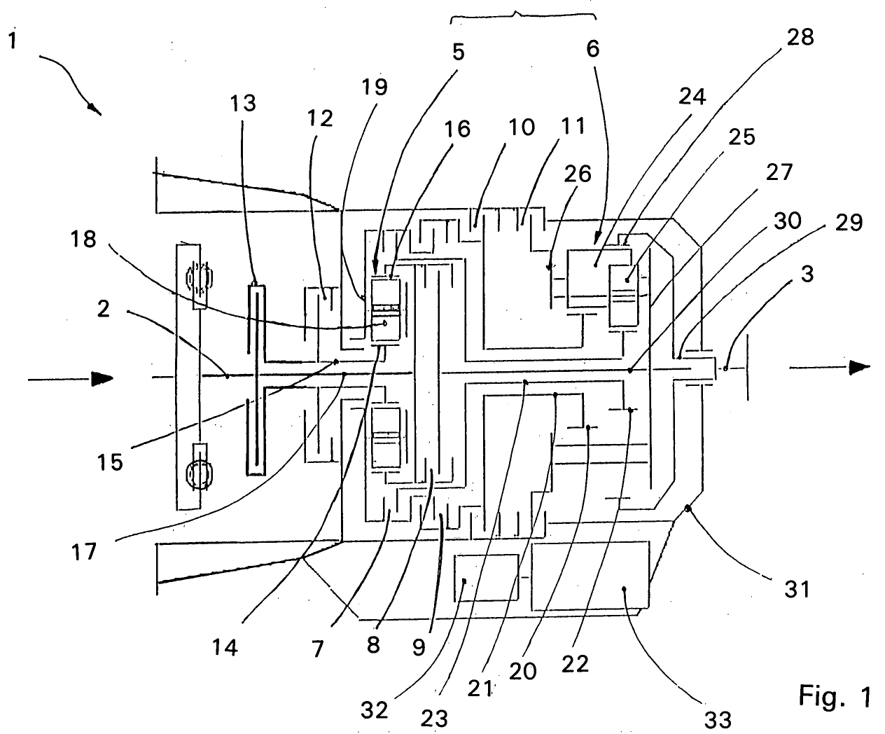

The single Figure, i.e. FIG. 1/1, shows an automatic shiftable vehicle transmission 1 in accordance with the present invention. This transmission 1 consists essentially of an input drive shaft 2 which, for example, at one end stands in communication with an internal combustion engine by means of a (not shown) torsion damper. On the output end of said input drive shaft is to be found an output drive shaft 3, which is connectable to at least one vehicle axle. Between the two said shafts, namely 2 and 3, is inserted a shifting gear train 4, which is composed of a first drive stage 5 and a second drive stage 6, with several clutches 7, 8, and 9 and brakes 10 and 11. The first gear stage 5 is, for example, constructed from a simple planetary gear set, which precedes a double planetary gear set namely a Ravigneaux-set made up of transmission stage 6. Such an arrangement enables, for example, an automatic, gear stage transmission with six forward gears and one reverse gear.

The sun gear 14 of the first planetary gear set 5 is connected to a start-up brake 12 by a sun gear shaft 15, so that a motor vehicle equipped with this transmission 1 is able to start-up without a hydrodynamic converter. The internal gear 16 of the first planetary gear set 5 is in continual connection with the input drive shaft 2 of the vehicle gear drive by an internal gear shaft 17. The planetary gears 18 are rotationally supported on a planet gear carrier 19, which said gears, by means of clutches 7, 8, 9 are connected to the second planetary gear set 6 or they can be blocked by the first brake 10 with the housing 31.

Between the input drive shaft 2 and the first planetary gear set 5 is provided, in accordance with the invention, an additional shifting element, for instance, a fourth clutch 13. The sun gear shaft 15 can be directly connected to the internal gear shaft 17 by means of this said clutch 13, whereby the first planetary gear set 5 can be blocked. On this account, the shifting element (clutch) 13 can be adjusted to a gear ratio i=1 at the first planetary gear set 5.

The second planetary gear set 6 consists essentially of a first sun gear 20 with a first sun gear shaft 21 as well as a second sun gear 22 with a second sun gear shaft 23. A set of first planetary gears 24 is supported on a first planetary gear carrier 26 and can be blocked by the brake 11 with the housing 31. The set of second planetary gears 25 is supported on a second planetary gear carrier 27, and by means of an intermediate shaft 30 as well as the clutch 8 can be connected to the first planetary gear set 5. The internal gear 28 of the second planetary gear set 6 is connected with the output drive shaft 3 of the vehicle transmission 1 by means of an internal gear 29.

Upon the closure of the clutch 13, the first planetary gear set 5 rotates in the block, so that by means of the combination of the first and the second planetary gear drives 5, 6, two additional forward and one additional reverse gear stages now exist. As a result, the invented transmission possesses nine forward gear stages and two reverse gear stages.

Reference Numbers and Corresponding Components

1 Vehicle transmission

2 Input drive shaft

3 Output drive shaft

4 Gear shift drive train

5 First planetary gear set

6 Second planetary gear set Ravigneaux Type, with 24 and 25

7 Shift element, first clutch

8 Shift element, second clutch

9 Shift element, third clutch

10 Shift element, first brake

11 Shift element, second brake

12 Shift element, third brake

13 Shift element, fourth clutch

14 Sun gear

15 Sun gear shaft

16 Internal gear

17 Internal gear shaft

18 Planetary gear

19 Planetary carrier

20 First sun gear

21 First sun gear shaft

22 Second sun gear

23 Second sun gear shaft

24 First planetary gear

25 Second planetary gear

26 First planetary carrier

27 Second planetary carrier

28 Internal gear

29 Internal gear shaft

30 Intermediate shaft

31 Housing

32 Pump

33 Electric motor

1. An automatic, shiftable vehicle transmission (1) with an input drive shaft (2), which can be connected to an internal combustion engine, and an output drive shaft (3) which is connectable to at least one vehicle axle, a mechanical shifting gear train (4) with a first and a second planetary gear set (5, 6), as well as a plurality of shifting elements (7, 8, 9, 10, 11, 12), whereby the first planetary gear set (5) is a simple planetary gear set and this said first planetary gear set (5) followed by a double planetary gear set, namely a Ravigneaux-set, as a second planetary gear set (6) therein characterized, in that an additional shifting element (13) is provided for the connection of a first shaft of the first planetary gear set (5) with a second shaft of the first planetary gear set (5).

2. An automatic, shiftable vehicle transmission (1) in accord with claim 1, therein characterized, in that by means of the additional shifting element (13) the sun gear (14) of the first planetary gear set (5) is connectable to the internal gear (16) of the first planetary gear set (5).

3. An automatic, shiftable vehicle transmission (1) in accord with claim 1 or 2, therein characterized, in that the sun gear (14) is connected to a sun gear shaft 15 and the internal gear (16) is bound to an internal gear shaft (17) and by means of the additional shifting element (13) the sun gear shaft (15) is connectable to the internal gear shaft (17).

4. An automatic, shiftable vehicle transmission (1) in accord with claim 3, therein characterized, in that the internal gear (17) of the first planetary gear set (5) is connected to the input drive shaft (2).

5. An automatic, shiftable vehicle transmission (1) in accord with one of the claims 1 to 4, therein characterized, in that the additional shifting element (13) is designed as a lamellate clutch.

6. An automatic, shiftable vehicle transmission (1) in accord with one of the claims 1 to 4, therein characterized, in that the additional shifting element (13) is designed as a shape-fit clutch.

7. An automatic, shiftable vehicle transmission (1) in accord with one of the claims 1 to 4, therein characterized, in that the additional shifting element (13) is designed as an over-running clutch.

8. An automatic, shiftable vehicle transmission (1) in accord with one of the foregoing claims, therein characterized, in that the additional shifting element (13) is located coaxially to the internal gear shaft (17) and/or to the sun gear shaft (15) and is axially placed between the input drive shaft (2) and the first planetary gear set (5).
